(19) United States
(12) Patent Application Publication
(10) Pub. No.: US 2011/0144972 A1
(43) Pub. Date: Jun. 16, 2011

(54) Method and System for Generating a Localized Software Product

(76) Inventor: Christoph Koenig, Ottobrunn (DE)

(21) Appl. No.: 12/636,221

(22) Filed: Dec. 11, 2009

(51) Int. Cl. G06F 17/28; G06F 9/44

(52) U.S. Cl. 704/2; 717/106; 717/110; 704/E13.011

(57) ABSTRACT

A method for generating a localized software product includes identifying textual elements in a software product and verifying that the textual elements comply with a set of restrictions of a controlled language. The method also includes translating the textual elements from the controlled language into a target language using a set of translation rules from a database and embedding the translated textual elements into a localized version of the software product.

### TECHNICAL FIELD

Embodiments of the present invention relate to a method and system for generating and executing a localized software product.

### BACKGROUND

Over the last couple of decades, the use and proliferation of computers has widely spread. In particular, in today's Internet age and globalized information society, people from all over the world use a large number of software products. Such software products include general purpose applications, such as web browsers, mail clients, text processors, spreadsheet applications or drawing programs, but also highly specialized tools such as scientific simulation tools and other domain-specific software. In addition, educational and entertainment software products are also widespread.

Many of these software products are available in a plurality of countries around the world. For example, mail clients and web browsers are used throughout the world to access the World Wide Web (WWW).

One challenge of the globalization of software markets is the need to provide fully localized software products for a plurality of destination countries. Among others, providing a software product translated into a local language of a destination market is a major challenge for small to medium-sized software providers. Even for large software providers, the effort it takes to translate all user interfaces and documents related to a particular software product and the software product itself represent a major cost factor. While manual translations are tedious to produce and expensive, machine translations often do not achieve the required quality for widespread use.

In consequence, fully localized versions of software products are only available for a relatively small number of local languages. For example, applications used only by a small number of specialists are usually only available in English. As a consequence, users who do not have English as their first language may be effectively barred from using the software product. Even if they have limited understanding of the English language, they may not be able to make best use of the software product due to communication difficulties. Furthermore, especially small to medium-sized software providers may lose potential income for smaller destination markets, if they choose not to localize their software products for these markets.

### SUMMARY

Various aspects of the present invention provide methods and systems that help to simplify the generation of localized software products. In particular, the methods and systems disclosed herein will help software manufacturers to provide fully localized software products automatically or semi-automatically with a reduced effort compared to conventional methods and systems.

Embodiments of the present invention relate to a method for generating a localized software product, an integrated software development environment, an execution environment for a software product, a localized software product and a system for generating a localized software product.

According to one aspect of the invention, a method for generating a localized software product is provided. The method comprises the steps of identifying textual elements in a software product, verifying that the textual elements comply with the set of restrictions of a controlled language, translating the textual elements from the controlled language into a target language using a set of translation rules from the database, and embedding the translated textual elements into a localized version of the software product.

By identifying textual elements and verifying that the textual elements comply with the set of restrictions of a controlled language, ambiguities deriving from linguistically unclear terms used in the development stage can be avoided at a later translation stage. If the textual elements are translated from the controlled language into a target language using a set of translation rules from the database, the translation can be performed automatically or, at least, semi-automatically. As a consequence, a localized version of the software product can be easily generated by embedding the translated textual elements.

According to a second aspect of the present invention, an integrated software development environment is provided. The development environment includes a resource manager for managing the resources associated with a software product, a resource analyzer for identifying textual elements within the resources managed by the resource manager, and an editor for editing the identified textual elements. The editor includes a verification tool for verifying that the identified textual elements comply with the set of restrictions of a controlled language.

By integrating an editor with a verification tool into an integrated software development environment, a software developer can make sure that textual elements of a software product comply with the set of restrictions of a controlled language at the time of development. Therefore, a subsequent localization process of the produced software product using automated translation tools is simplified.

According to a third aspect of the present invention, an execution environment for a software product developed using a controlled language is provided. The execution environment includes at least one software product that includes instruction code and textual elements. The execution environment further includes a client interface adapted to determine a local language of a client requesting execution of the at least one software product and an execution engine for executing a localized version of the at least one requested software product. The localized version of the executed software product includes the instruction code and textual elements translated from the controlled language into the determined local language of the client interface.

By determining the local language of a client at the time of execution, an execution engine may run a fully localized version of a requested software product including textual elements translated into the determined local language of the client. This is particularly useful for execution environments on the Internet, in which the client requesting execution of the software product does not necessarily share the same local language with the host providing the at least one software product.

According to further aspects, a localized software product obtained by one of the proposed methods and a system for generating a localized software product are disclosed.

Further aspects of the present invention are disclosed in the following subsequent detailed description of currently preferred embodiments and the claims attached hereto.

### BRIEF DESCRIPTION OF THE DRAWINGS

FIG. 1 shows a schematic diagram of a software development process of the present invention;

FIG. 2 shows a schematic diagram of a conventional software development process;

FIG. 3 shows a flow chart of a method for generating a localized software product according to an embodiment of the proposed software development process;

FIG. 4 shows a schematic diagram of an integrated software development environment for use with the suggested software development process;

FIGS. 5A and 5B show exemplary dialog windows including textual elements in two different local languages; and

FIGS. 6A and 6B show schematic diagrams of different software execution environments for executing localized versions of a software product.

### DETAILED DESCRIPTION OF ILLUSTRATIVE EMBODIMENTS

The advantages of the proposed method and systems may best be understood by comparison with a traditional software development process. An example of such a development process will be described next.

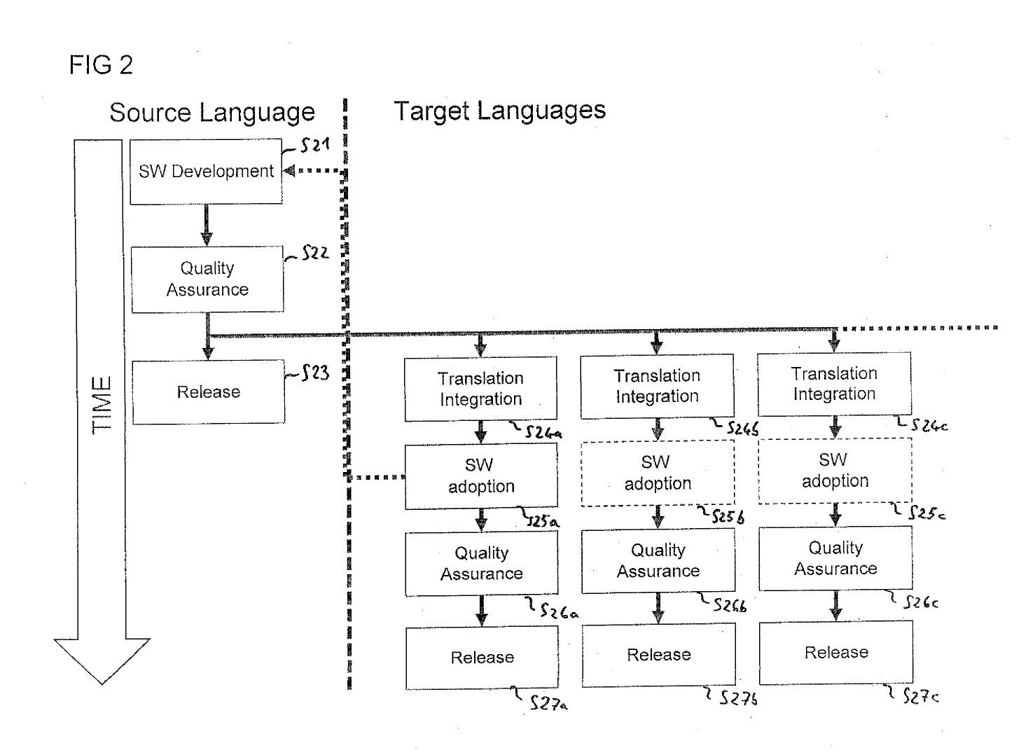

FIG. 2 shows such a conventional software development process. On the left-hand side of FIG. 2, the development process for a software product for the local market of the software producer is shown. On the right-hand side of FIG. 2, the development process for localized versions of the software product for other destination languages is shown.

Traditionally, at a first step S21, a prototype version of a software product is developed in a source language. More specifically, textual elements related to the software product such as specifications, user interface elements, manuals and other textual elements are produced initially in the source language. In the subsequent description, the development language referred to as “source language” always refers to the language of these and similar textual elements and not, as commonly used, to the programming language, in which the actual instruction code of the software product is written. However, source code files may include textual elements requiring translation, such as comments and literal strings, in addition to the instruction code, which does not need to be translated.

Typically, the software product is developed in the native language of the software developer, or the local language of the company producing the software. Alternatively, in particular, if software development is outsourced to foreign countries, such as India or China, the software is developed in a language understood in the main market for the developed software product. Often, the software product will be developed in the English language first.

While modern software development environments support the separation of certain textual elements, such as help files and online tutorials, from the instruction code of a developed software product, at least some textual elements of a software product will typically be hard coded into the developed software product. In particular, textual elements of dialog boxes are often encoded directly into the instruction code or resource files representing a graphical user interface. Such textual elements pose a considerable problem during the localization stage as detailed further below.

In a subsequent step S22, the developed prototype software product undergoes quality assurance. At that stage, both the functionality and the documentation of the developed software product may undergo extensive testing. If the prototype software product fails the quality assurance, it will be sent back to the software development stage in step S21.

However, if the prototype software product complies with the guidelines set for the quality assurance, a release candidate will be provided in step S23. The release candidate is directed at the market associated with the source language, e.g., the English language market.

At the same or a later time, the resources used to produce the release candidate of the software product may be provided to one or multiple translation processes in steps S24a to S24c, respectively. In these steps, the textual elements from the release candidates are translated into different destination languages according to selected destination markets. For example, the textual elements of dialog windows of a user interface, help files and online tutorials may be translated into German, French, or Chinese, respectively.

The translated textual elements are then integrated with the software product to form a translated software product. For example, strings occurring in the source code of the release candidates are replaced with translated strings. References to a resource file relating to an English online tutorial are replaced with a reference to a corresponding translated online tutorial and so on.

Due to the difference in grammar and the complexity of different languages, the translated textual elements often do not fit into the dialog boxes as generated for the initial prototype software. In particular, a translated textual element may be longer than the original textual element in the source language. Other anomalies associated with localization of a software product may exist. For example, a different mechanism for representing characters in the destination language such as double byte encoding may exist. For these reasons, at steps S25a to S25c, the localized software products may require alterations beyond the translation of the individual textual elements. Therefore, at this stage, a feedback loop to the initial software development at step S21 may be necessary. In particular, the instruction code or layout of the dialog box may have to be changed.

This is a particularly costly operation since not only the localized versions of the software product must undergo further changes but also the original version of the software product that had already passed quality assurance in step S22. In consequence, a further quality assurance step S22 and a further release step S23 may be necessary for the initial version in the source language.

Equally, the localized versions of the software product must undergo quality assurance in steps S26a to S26c. In this step, both the quality of the provided translation as well as the integration of the translated textual elements into the original software product is verified.

At last, in steps S27a to S27c, localized versions of the software product may be released to different destination markets such as Germany, France, and China, respectively.

As can be seen from FIG. 2, the conventional software development process is both complex and time consuming, as potential problems with localized versions of a software product can only be identified and corrected late in the development process. Furthermore, changes in any version of the localized software product may require a full re-run of the entire development process for all versions of the software product. In addition, the time at which the release of the localized versions takes place is often much later than the initial release of the source software product in step S23. This is a particular challenge for global marketing as different localized versions of the same software product cannot be easily offered globally at a same point in time.

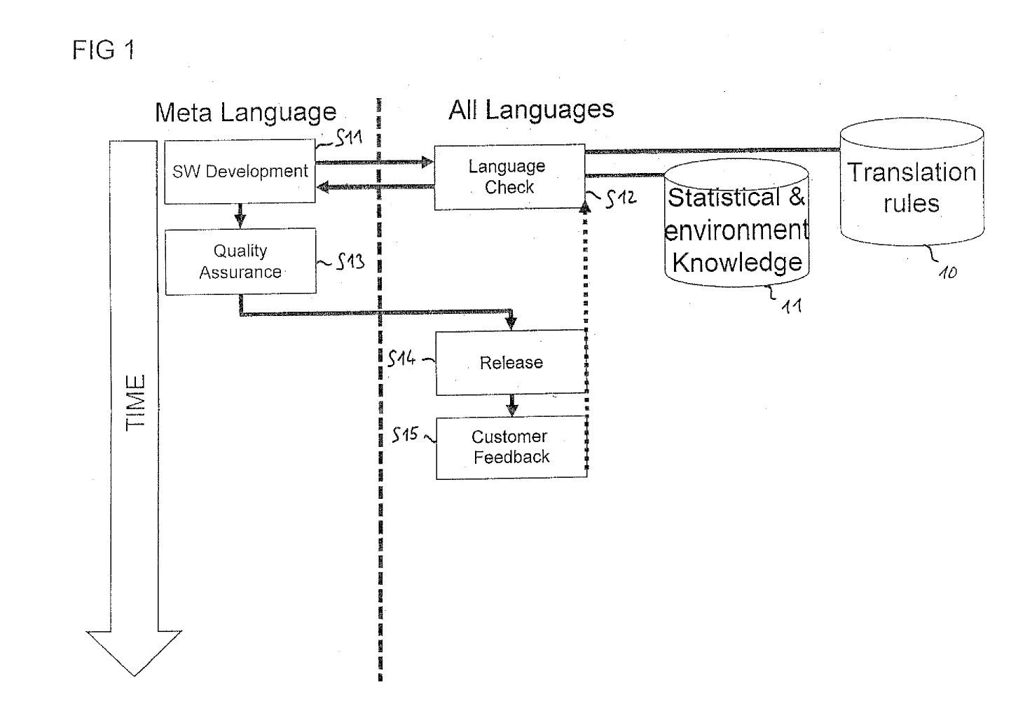

FIG. 1 shows an improved software development process. On the left-hand side of FIG. 1, the software development process in the source language is shown. On the right-hand side of FIG. 1, the localization process for the developed software product is shown.

In a step S11, the software product is developed. During development, the programmer makes use of a controlled language for all textual elements. Controlled languages are languages that are restricted by a set of restrictions regarding the allowed vocabulary and/or structure of the expressions being created in the language. In this way, the textual elements included in the software product adhere to a restricted vocabulary and/or regular grammar that is amenable to automatic or semi-automatic translation. The use and details of restricted or formal languages are known from linguistic research and are therefore omitted from this description. By way of example, reference is made to the application of controlled languages in so-called expert systems, in which correctness and unambiguousness of documents is important.

Preferably, the development environment in which the development is performed in step S11 supports and enforces the rules of the controlled language. For example, an editor with a built-in verification tool may be used to analyze textual elements in the background and highlight terms that are not in compliance with the set of rules of the controlled language. Alternatively, the correctness of the textual elements may be verified on request, e.g. after completion of a certain section of code, a subsystem of the software product, a particular document or the like. For example, the correctness of all textual elements may be verified at a deployment stage and/or before the developed software product is send to a quality assurance unit.

These language checks are performed in step S12 during the development stage. If the verification tool identifies ambiguous terms, the developer of the software product can be prompted to identify which of several possible meanings is intended by the actual textual element. In this way, clarification and improvement of textual elements is performed at a very early stage of the development process.

When the textual elements of the developed software product are in compliance with the set of rules of the restricted language, an automatic translation into a specified target language can be performed. For this purpose, a database including translation rules is provided.

In the described embodiment, the database includes the rules of the restricted language and a set of fixed translation rules 10 that are specific to a particular target language. In addition, the database may comprise additional information regarding statistical and environmental knowledge 11 for the specific software product. For example, a vocabulary specific to the application area of the software product may be integrated into the translation database.

The subsequent quality assurance is performed only once in step S13. At this stage, only the functionality of the developed software product needs to be assessed. Particularly, any possible ambiguity of the textual elements of the software product has already been resolved in steps S11 and S12 during the development process.

Consequently, in a step S14, a localized version of the software product may be generated readily for any desired target language for which translation rules exist in the translation database. Among others, this helps to support global releases of a particular software product.

Although translations from a controlled language as a source language into a specified target language are generally of high quality, individual terms specific to a particular area of application may still be mistranslated. In order to improve the quality of the translation of the localized software product, and also to improve the quality of the translation of future software products, in a step S15 of the preferred embodiment, customer feedback may be provided to a translation service provider. In particular, a customer may select a mistranslated textual element in a localized version of a software product and activate a feedback function provided in the software product. Thus, a customer may provide valuable feedback to the software developer at a touch of a button.

In an even more sophisticated embodiment, the customer may also provide a suggestion of a better translation for the specific textual element of the localized version of the software product. In that case, the producer of the software product also benefits from domain specific, localized knowledge of its customer base. The suggested translation may be verified and can then be entered into the statistical or environmental knowledge base 11.

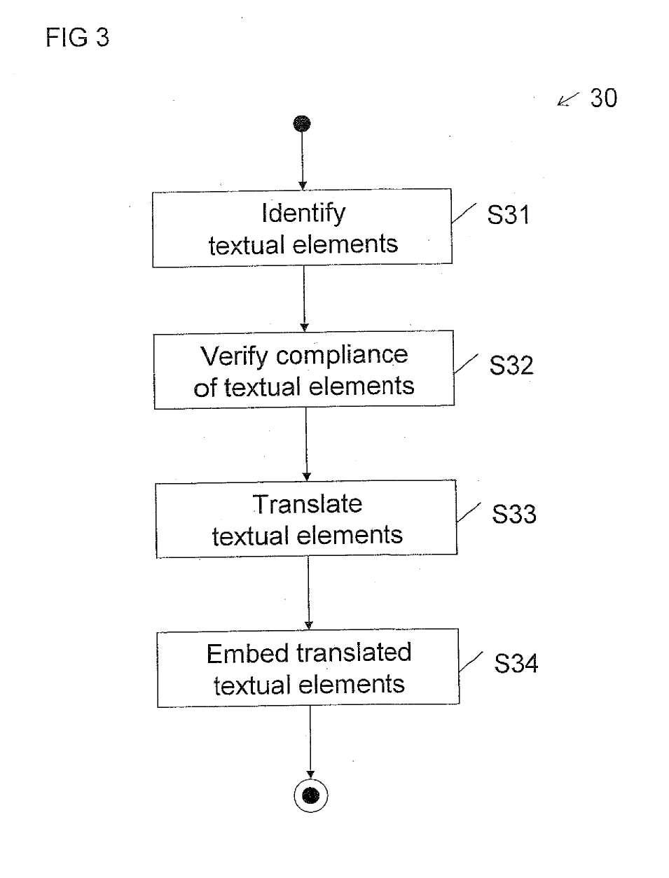

FIG. 3 shows a flow chart of an exemplary embodiment of a method for generating a localized software product. In a first step S31, textual elements of a software product are identified. Preferably, the textual elements are identified during the development stage of the software product. In particular, an integrated software development environment may provide tools for the identification of textual elements in different types of resources associated with the software product under development.

Examples of textual elements identified in step S31 are individual character strings embedded in a source code of a software product, documents associated with the software product such as online help files, interactive tutorials or manuals, elements of a user interface, such as button labels or window titles, or any other individual or predefined textual elements such as messages provided by a general purpose library. Depending on the type of the textual elements, identification may require a syntactical analysis of a particular resource of a software product, such as its source code, or merely the identification of a particular type of a resource. For example, text strings within a source code file can be identified using a syntactical analysis for the grammar of the particular programming language used. On the other hand, the entire content of a help file may be identified as a textual element.

According to the embodiment, textual elements identified in step S31 are marked for later processing. In particular, meta-information may be stored in a resource manager or repository in which a particular resource is stored.

In a subsequent step S32, the compliance of each individual textual element with the controlled language is verified. In particular, in step S32, the syntax and semantic of the identified textual elements is established. If the textual elements deviate from the grammar as implied by the controlled language, the corresponding textual element is highlighted for correction by the software developer. In addition, individual terms of identified textual elements may be highlighted for clarification. For example, ambiguous terms of the controlled language may be highlighted. The software developer can then be presented with a choice of the individual meanings of the highlighted terms to further clarify the textual element.

For example, the term “select” may represent the adjective “select” or the verb “to select”, which can be determined automatically based on a syntactical analysis. In addition, the verb “to select” has different meanings, for example to mark a particular entry or to choose a particular entry. Accordingly, the software developer might be presented with a list of choices for a given term in order to clarify it further. The further clarification of a textual element is stored as part of the textual element itself or as meta-information associated therewith. For example, the textual element comprising the term “select” may be amended to comprise the term “select[choose]” to resolve any ambiguity.

In addition, a developer may provide further information to the translation process using mechanisms provided in the controlled language. As an example, a software developer may mark individual terms of textual elements as immutable. For example, proper names such as names of people, places or trademarks should be excluded from automated translation processes. As an example, the term “Microsoft Office” should not be translated and could be marked up accordingly.

Once the compliance of the textual elements of a software product has been successfully verified, these elements can be translated automatically or semi-automatically in a step S33. Translation may be performed by an automatic translation system based on translation rules 10 for a translation from the controlled language into one or several specified target languages.

For domain-specific software products, for example, for software products relating to a specific profession such as law or engineering, domain-specific vocabulary and statistical knowledge 11 may be applied during the translation process. In this way, the quality of the automatic translation may be improved.

In case of a controlled language based on the English language and English as the target language, the automatic translation process may be restricted to stripping the additional meta-information and mark-up from the localized version.

In a step S34, the translated textual elements are embedded into the software product. Depending on the type of the resource being processed and the textual element in question, this may take different forms. In case of documents that include large amounts of text, such as help files or instruction manuals, a separate document with a translated version of the entire help file or document may be created. Such separate resources may be embedded into the software product by means of references such as file names or hyperlinks. In case of individual strings embedded in the program code of the software product under development, like the labels of buttons of a user interface, the strings may be replaced within a localized version of the source code or an associated resource file itself.

In order to guarantee the correctness of the localized software product, the instruction code of the software product may be adapted to make it resistant to the embedding of translated textual elements. For example, the dimension of textual elements of a user interface may be enlarged to fit the longest possible translation of a particular term. Corresponding textual elements in other localized versions of the textual elements may be extended to the required length by adding blank characters, for example. In addition, it is ensured that the infrastructure requirements for any of the selected target languages are in place. In particular, double byte encoding is enabled for Asian languages and the like.

As explained above, the process for generating a localized software product only requires interaction from the software developer at steps S31 and S32. That is, steps S33 and S34 can be performed at a later stage independently of the software development product. In particular, the translation of the textual elements of a software product and the embedding of the translated textual elements may be performed at a deployment stage or a run time of the software product. This will be explained later in more detail with respect to different execution environments for the software product.

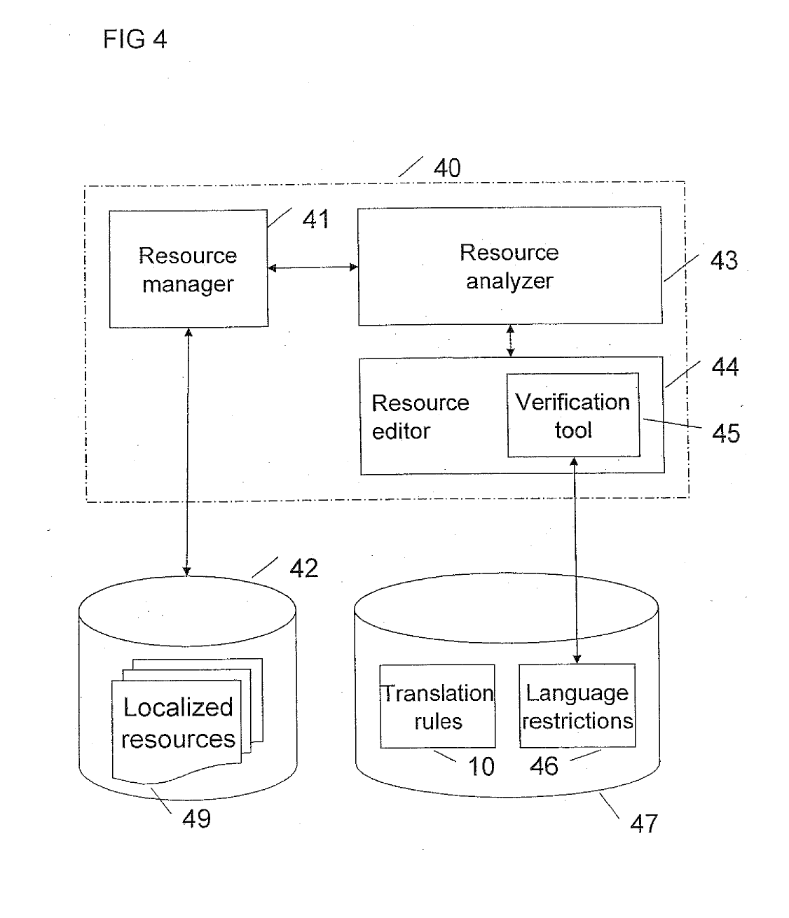

The development stage can be further improved by provision of an integrated development environment, which is described next with reference to FIG. 4.

The exemplary integrated software environment 40 includes a resource manager 41. The resource manager 41 manages different resources for a software product under development. Among others, the resource manager 41 manages source code files, resource libraries, such as files including message texts used by the software product, help pages, object files, configuration files and other resources associated with the software product. These resources are stored in a repository 42. The repository 42 may allow the storage of different versions of the same resource, such as different localized resources 49, and typically stores meta-information associated with a particular resource or version thereof.

Resources retrieved by the resource manager 41 are analyzed by a resource analyzer 43. The resource analyzer determines the type of a particular resource, i.e., if it is a source code file or a part of the documentation or any other type of resource, and provides it to an editor 44, which is adapted to edit this particular type of resource. For example, source code files and documentation files may be passed to a text editor. As another example, a resource file describing a component of a graphical user interface, such as a dialog box, may be passed to a graphical interface editor. The resource editor 44 comprises resource-specific tools to analyze and verify the resource under consideration.

In particular, the resource editor 44 may include a syntactical analyzer and a verification tool 45 that verifies that the opened resource complies with a predefined set of rules. In the case of a source code editor, at first, the different syntactical elements of the source code file are analyzed. For example, instructions, comments and textual elements of a source code file are identified. Then, the individual parts of the source code are sent to a content-specific verification tool 45.

Among others, the verification tool 45 of the resource editor 44 verifies that the textual elements of the source code file comply with the set of language restrictions 46 comprised in a database 47. The language restrictions 46 define a controlled language. For example, the language restrictions might determine the structure of the possible sentences expressed in the controlled language and also restrict the vocabulary of that language.

Optionally, the database 47 may also include translation rules 10 and domain specific knowledge that are used to automatically translate the identified textual elements. In this way, automatically generated translations for each textual element may be provided to the integrated development environment 40. The translated textual elements may be displayed to a developer for verification or may be stored by the resource manager 41 in the form of localized resources 49.

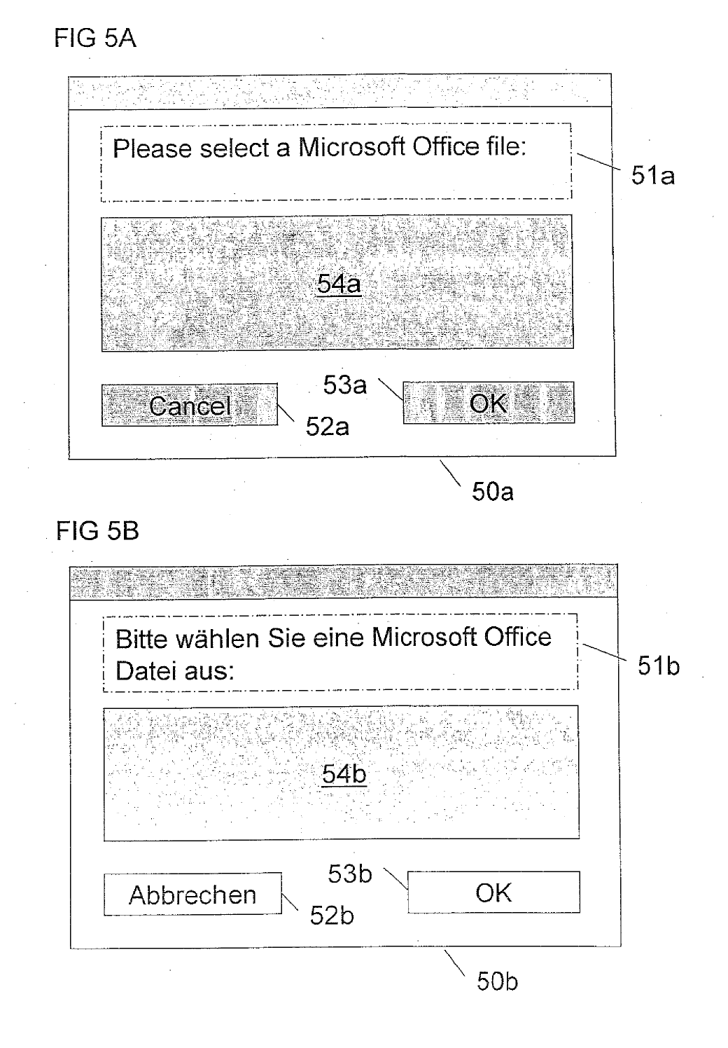

FIG. 5A and FIG. 5B show an example of a dialog box 50 being created by the integrated development environment 40. The dialog box 50 comprises a text box 51, two push buttons 52 and 53 and a file selection element 54. An English localized version of the dialog box 50a is shown in FIG. 5A. A corresponding German localized version of the dialog box 50b is shown in FIG. 5B.

As can be seen in FIGS. 5A and 5B, the lengths of the textual elements of the text boxes 51a and 51b, respectively, differ. In particular, the German translation of the textual elements is longer than the English language version thereof, which was used during development.

To test whether longer versions will fit into the text box 51a, its textual content can be extended by adding special text during software development. For example, a character string “Short” could be extended by one or more special characters to “Short______<” to fit the longest possible translation. During testing, the tester than verifies that the last character, i.e., “<” remains visible in the text box 51a. In the released version of the software product in the source language, the special characters will be removed. In other versions of the software product for other target languages, the textual content will be replaced with the actual translated textual element.

Alternatively, the textual element associated with the text box 51a shown in FIG. 5A is extended by blank characters in the source language beyond its normal length. In particular, a blank line is added in the English language version of the textual element 51a. In this way, sufficient space for the translated German textual elements 51b is available in the dialog box 50b.

Equally, the size of the label of the push buttons 52a and 53a is selected in such a way that the longer translated textual elements serving as a label button will fit onto the push buttons 52b and 53b, respectively, without further adaptation of their size or layout.

Different mechanisms for supporting these and similar layout options may be provided by the respective resource editors 44 of the integrated development environment 40. Among others, a statistical prediction of the length of particular textual elements may be made based on linguistic analysis of the source and potential target languages. For example, 30% extra space may be provided for translations of English textual elements into corresponding German textual elements. If translation rules 10 or domain-specific knowledge are available to the integrated development environment 40 as shown in FIG. 4, the determination can be made based on the actual translation of the textual element into target language rather than a statistical estimate.

As detailed above, the translation of textual elements may be provided at a development stage already. However, in accordance with different embodiments of the invention, the selection of a localized version and/or provision of translated textual elements may be provided at the run time of a particular software product.

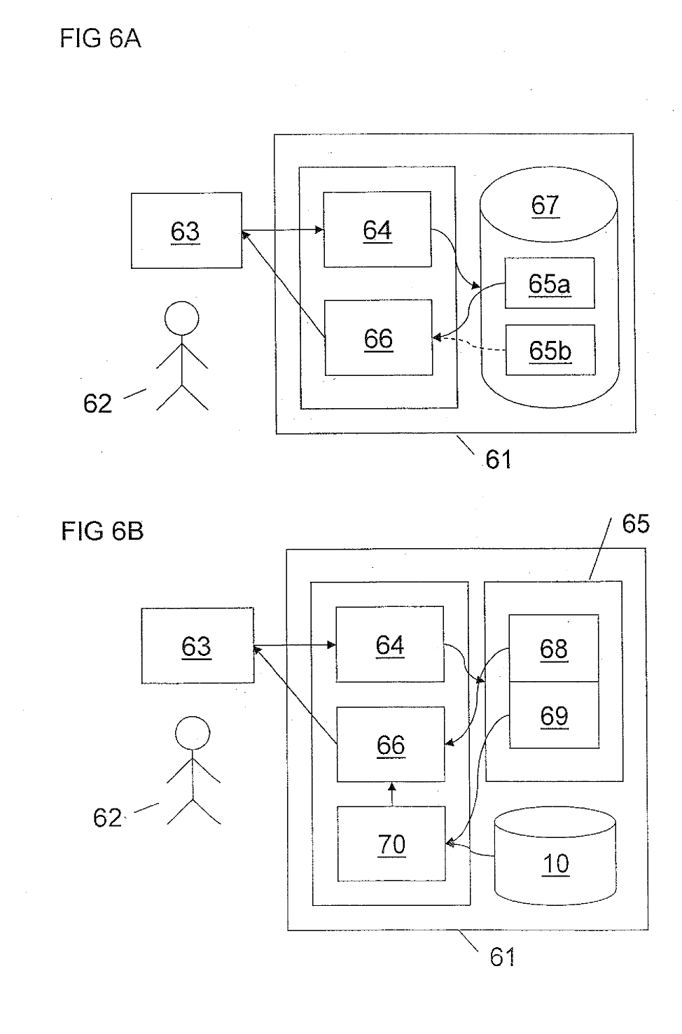

FIGS. 6A and 6B show different execution environments for the execution of a localized software product.

FIG. 6A shows a execution environment 61 for executing different localized versions of a software product. For example, the execution environment 61 may be an application service provider providing the software product as a service (SaaS) in an English or German language version.

A user 62 requests access from a client system 63 of a particular software product by means of a client interface 64. For example, the user 62 might log into a web service of the application service provider by means of a web browser. The client interface 64 determines the local language of the user 62. For example, the client interface 64 may analyze an environment variable of the client system 63 or retrieve a local language setting of the user 62 from a database associated with the log-in credentials of the user 62.

Once the local language of the user 62 has been determined, the client interface 64 selects one of several localized versions of the requested software product provided in the execution environment 61. For example, an English version of the requested software product 65a or a German localized version of the requested software product 65b may be accessible to the execution environment 61. The localized version of the requested software product is then executed in an execution space 66 for the user 62 in accordance with the language setting of the user 62.

In the scenario depicted in FIG. 6A, complete localized versions of the particular software product are stored within a software repository 67 of the execution environment 61. That is, the localized version 65a and 65b may be provided by the software producer and include a static or dynamic binding to localized versions of all textual elements. As a consequence, the textual elements of the software product only need to be translated once according to the scenario of FIG. 6A.

In contrast, in a second scenario depicted in FIG. 6B, the textual elements of a particular software product stored in a software repository 67 are translated on-the-fly, i.e. at run time. More particularly, a software product 65 comprises code elements 68 and textual elements 69. While the code elements 68 are immutable for all localized versions of the software product, the textual elements 69 are replaced by translated textual elements upon access.

For this purpose, a user 62 logs into a client interface 64 by means of a client system 63 as described above. When the client interface 64 has determined a local language of the user 62, it executes the software product from the software repository 67. According to a first alternative, all textual elements 69 are translated by a translation engine from the controlled language into the determined target language upon loading of the software product into the execution space 66. Alternatively, the software product including the textual elements 69 in the controlled language may be loaded into the execution space 66. Whenever a textual element 69 is encountered during the execution of the computer code 68, the translation engine 70 is activated to translate the identified textual element into the local language of the user 62. In this way, the most up-to-date translation of the textual elements 69 is available at run time. That is, if translation rules 10 or domain specific knowledge stored in the translation database is updated, all localized versions of the software product 65 will make use of the most up-to-date translation immediately.

One particular advantage of the various embodiments described above is that a feedback loop from the user 62 to the developer of the software product may be provided. For example, if the user 62 accesses a software product 65 either locally or in an execution environment 61 described with reference to FIG. 6A and FIG. 6B, he or she might encounter an incorrect or misleading translation of a textual element. In that case, the user 62 may highlight the translated textual element and provide feedback to the developer of the software product 65. If the user 62 has particular knowledge about the relevant application area, he may also be capable of providing an improved translation to the software manufacturer. In that way, the quality of the translation of textual elements 69 of a software product 65 may be greatly enhanced using the distributed knowledge of its user base.

For this purpose, the software product 65 manufactured by the software producer comprises a feedback module (not shown), which allows context-sensitive feedback from the user 62. The gathered information, such as the textual element in question, the version of the software product 65 used and its localization may be provided with or without a suggested translation back to the software manufacturer or to the service provider providing the translation database. Such information may be either used to improve the static translation rules 10 or to define exceptions or domain-specific translation rules in the knowledge database.

Preferably, each software product 65 manufactured using the above methods and systems therefore includes a communication module which is capable of communicating with the service center of the software producer or translation service provider. For example, a web service accessible over the Internet may be used to provide feedback information about possible translation errors to the software manufacturer.

Furthermore, the approach to localizing software products presented above also helps to better define the interfaces between software developers on the one hand and translation specialists on the other. In particular, the developers of a software product are freed from the task of adapting the developed software product to specific needs of a localized version as no further manual changes are required at the localization stage. In addition, feedback regarding the translation in the localized versions can be directed to the translation service provider directly without interference from the program designer. As a consequence, the task of software development and translation can be performed by separate entities without the need for a feedback loop from the translation service provider to the software developer.

As a further advantage, the use of a controlled language in software development results in better documentation and quality of produced software products. At the same time, it greatly speeds up and increases the availability of fully localized software products.

While currently preferred embodiments of the invention have been described above, a person skilled in the art will appreciate that many other advantages and possible implementations of the concepts described herein can be obtained by making use of controlled language in software development. The details of the embodiments described above should therefore not be construed as limitations of the inventive concept as defined by the appended claims.

What is claimed is:

1. A method for generating a localized software product, the method comprising:
identifying textual elements in a software product;
verifying that the textual elements comply with a set of restrictions of a controlled language;
translating the textual elements from the controlled language into a target language using a set of translation rules from a database; and
embedding the translated textual elements into a localized version of the software product.

2. The method according to claim 1, wherein the identifying and/or verifying are performed at a development stage of the software product.

3. The method according to claim 1, wherein the identifying and/or verifying are performed at a deployment stage of the software product.

4. The method according to claim 1, wherein the translating and/or embedding are performed at a deployment stage of the software product.

5. The method according to claim 1, wherein the translating and/or embedding are performed at a run time of the software product.

6. The method according to claim 1, wherein the translating comprises:
determining a context of the textual elements;
providing a set of generic translation rules for the target language;
providing a set of context-specific translation rules for the target language; and
translating the textual elements based on the set of generic translation rules and the set of context-specific translation rules.

7. The method according to claim 1, wherein the verifying comprises:
identifying ambiguous terms of the textual elements;
requesting clarification regarding the identified ambiguous terms from a producer of the software product; and
replacing the identified ambiguous terms with unambiguous terms based on the requested clarification.

8. The method according to claim 1, wherein
the verifying further comprises identifying fixed terms in the textual elements; and
the translating comprises excluding the identified fixed terms from a translation.

9. The method according to claim 1, wherein the embedding comprises enabling support for a target language specific character set.

10. The method according to claim 1, wherein the software product comprises a user interface and wherein the embedding comprises extending a display area of the textual elements according to a length of the translated textual elements.

11. The method according to claim 1, further comprising:
identifying a textual element comprising a translation error in the localized version of the software product;
sending a notification message to a service provider, the notification message comprising an identifier associated with the localized version of the software product and the identified textual element; and
correcting the identified textual element and providing an updated translation rule to the database.

12. An integrated software development environment, comprising:
a resource manager for managing resources of a software product;
a resource analyzer for identifying textual elements within the resources managed by the resource manager; and
an editor for editing the identified textual elements, the editor comprising a verification tool for verifying that the identified textual elements comply with a set of restrictions of a controlled language.

13. The integrated software development environment of claim 12, further comprising a translation tool for automatically or semi-automatically translating the identified textual elements from the controlled language into a designated target language.

14. The integrated software development environment of claim 13, further comprising a database, the database comprising a set of generic translation rules for the designated target language and a set of context-specific translation rules for the designated target language, wherein the translation tool is further adapted for determining a context of the identified textual elements and translating the identified textual elements based on the set of generic translation rules and the set of context-specific translation rules in accordance with the determined context.

15. The integrated software development environment of claim 13, wherein the software product is associated with at least one target language and the translation tool is adapted to translate the identified textual elements associated with the software product into at least one associated target language and to provide the translated textual elements to the resource manager.

16. The integrated software development environment of claim 13, further comprising a deployment tool for building a localized version of the software product from the resources managed by the resource manager comprising textual elements translated into the designated target language by the translation tool.

17. An execution environment for software product developed using a controlled language, comprising:
at least one software product comprising instruction code and textual elements;
a client interface adapted to determine a local language of a client requesting execution of the at least one software product; and
an execution engine for executing a localized version of the at least one requested software product, the localized version of the executed at least one software product comprising the instruction code and textual elements translated from the controlled language into the determined local language of the client interface.

18. The execution environment of claim 17, further comprising a plurality of localized versions of the at least one software product, each localized version comprising the instruction code and textual elements translated from the controlled language into a target language associated with the localized version, wherein the execution engine is adapted to execute the localized version of the at least one software product associated with the determined local language of the client.

19. The execution environment of claim 17, further comprises a resource manager for storing a plurality of translated sets of the textual elements translated from the controlled language into a target language, each set of the translated textual elements associated with the target language, wherein the execution engine is adapted to execute the at least one software product comprising the instruction code and the set of translated textual elements associated with the determined local language of the client.

20. The execution environment of claim 17, further comprising a translation engine for automatically translating textual elements of the controlled language into the determined local language of the client, wherein the execution engine is adapted to translate the textual elements from the controlled language into the determined local language upon execution of the instruction code.

21. A localized software product comprising instruction code and textual elements obtained by the method of claim 1.

22. The localized software product according to claim 21, further comprising a feedback module for providing feedback on a translation of a textual element comprised in the software product, the feedback module being operable to generate a feedback message to a predetermined service provider upon activation by a user.

23. A system for generating a localized software product, the system comprising:
identification means for identifying textual elements in a software product;
verification means for verifying a compliance of textual elements with a set of restrictions of a controlled language;
translation means for automatically or semi-automatically translating textual elements from the controlled language into a target language using a set of translation rules; and
embedding means for embedding translated textual elements into a localized version of the software product.
